(19) United States
(12) Patent Application Publication
(10) Pub. No.: US 2025/0162266 A1
(43) Pub. Date: May 22, 2025

(54) Tripul Pultrusion System

(71) Applicant: Pulflex Technologies LLC, Ford City, PA (US)

(72) Inventor: Steven Mansfield, Beaver Falls, PA (US)

(73) Assignee: Pulflex Technologies LLC7-, Ford City, PA (US)

(21) Appl. No.: 18/948,433

(22) Filed: Nov. 14, 2024

Related U.S. Application Data
(60) Provisional application No. 63/548,431, filed on Nov. 14, 2023.

(51) Int. Cl. B29C 70/52

(52) U.S. Cl. CPC B29C 70/527; B29C 70/528

(57) ABSTRACT

A pultrusion system for preparing a fiber reinforced polymer composite includes three movable sleds positioned adjacent one another and longitudinally aligned with one another to feed a composite material through a system. Each of the sleds has an open position and a closed position, with the closed position being utilized to clamp down upon and pull a composite material through the pultrusion system. The system provides for two of the three sleds to be in contact with the composite material to move the composite material through the system at any one time.

### CROSS-REFERENCE TO RELATED APPLICATION

The present invention claims priority to U.S. Provisional Application No. 63/548,431, filed on Nov. 14, 2023, the disclosure of which is incorporated herein by reference in its entirety.

### FIELD

The present invention concerns a tripul pultrusion machine for pulling material and a pultrusion method.

### BACKGROUND

The use of pultrusion processes to form composite structures has become increasingly popular since it enables structures to be fabricated on a continuous basis. Pultrusion is a manufacturing process that creates fiber-reinforced composite materials, such as glass filaments, or other reinforcing materials such as carbon and high strength organic fibers with a constant cross-section and long lengths. In pultrusion, continuous fibers are pulled through a resin bath to impregnate them, then through a heated die to cure the resin and form the solid composite profile. Pultrusion is used to create lightweight, high-strength composite products with consistent quality. Some advantages of pultrusion include:
Strength-to-weight ratio: pultruded composites are stronger than steel but lighter, making them less expensive to transport and easier to work with.
Durability: Pultruded composites are durable and can withstand harsh conditions, like water, chemicals, and salt.
Pultrusion is a fast and economical process.

Today, one of the most persistent hurdles to overcome in pultrusion is the variable pull force associated with two platen pullers. FIG. 1 depicts a prior art platen system 1 used commonly in pultrusion processes. The prior art system utilizes two sleds 2, 3 that each pull the composite material 4. Material 5 is fed into the system 1 from the right side of the schematic in the form of fiber and resin. The fiber/resin combination 5 enters a die 6 that is positioned on the right side of the schematic. This composite material 4 travels through the system until it is cut off at the end by a saw 7. The composite material 4 first enters the first Sled 2, which opens to receive the composite material 4 and pulls the composite material 4 leftward in the system 1, as shown in the schematic. As the first Sled 2 completes its travel distance, the second sled 3 opens and clamps down on the material to continue to pull the composite material 4 leftward, while the first sled 2 opens to release its grip on the composite material 4. As the second Sled 3 continues pulling the composite material 4 leftward, the first Sled 2 travels to the right to its starting position where it then clamps down on the composite material 4 as the second Sled 3 completes its travel distance as second Sled 3 releases the composite material 4. The first Sled 2 then travels leftward in the schematic as the second Sled 3 returns to its starting position. The process continues with the sleds 2, 3 switching with one another to move the composite material 4 from right to left. The motion of the two sleds 2, 3 is coordinated so that the movement of the composite material 4 is nearly continuous. When the composite material 4 reaches its desired length, a saw 7 is used to cut off the composite material 4.

The current methodology often has deficiencies in constant pull force and speed during the handoff between sleds (pullers) 2, 3. For example, current systems have a slight hand-off pause when the composite material 4 is transferred from the first sled 2 to the second sled 3. This creates a mark in the part, which is undesirable. The immediacy to ameliorate this issue becomes exponential as this market, and materials and their capabilities are now being readily understood.

With shape complexity, resin and fiber loadings increasingly pushing the process envelope, the need to develop a new method to ensure a consistent and uniform process and decrease the opportunity for puller sled slippage is desired. A new process is desired to enhance the levels of consistency in esthetics to the finish and to improve overall part geometry. The present invention addresses these needs. The present invention is intended to solve many known deficiencies in the current process.

### SUMMARY

According to the invention, a pultrusion system for preparing a fiber reinforced polymer composite includes a movable first sled, a movable second sled, and a movable third sled. Each of the sleds has an open position and a closed position, with the closed position being utilized to clamp down upon and pull a composite material through the pultrusion system. Each of said first, second, and third sleds are movable from a starting position to an ending position and are returnable to the starting position. The first end of the system is for receiving a composite material to be pulled. A second end of the system is located opposite the first end of the system. The system includes computer programming, a computer, and a controller to permit the first, second and third sleds to pull the composite material through the pultrusion process in a substantially continuous manner from the first end to the second end. Two of the first, second, and third sleds are in contact with the composite material and pulling the composite material at any one time.

The composite material may be pulled through the system in a continuous manner. The composite material may be pulled through the system in a substantially continuous manner, without any discernable pauses.

The system may include a heated die positioned at a first end of the system through which the composite material is pulled. The system may include a cutting mechanism for cutting the composite material at the second end. The cutting mechanism may be a saw.

Each of the sleds may be aligned longitudinally with one another along a production line and may be spaced from one another by an intermediate spacing. The intermediate spacing between the sleds may be equal for each sled. The system may include a means for moving and opening and closing the sleds. Each sled hereof applies a clamping force to the composite material when the sled closes on the composite material. A level of clamping force is associated with a two-sled protrusion system, and the level of clamping force applied by the sleds hereof is about half of the clamping force associated with a two sled protrusion system.

In a second embodiment, a pultrusion process for preparing a fiber reinforced polymer composite and for moving the composite from a first end of a system to a second end of the system includes a first movable sled, a second movable sled, and a third movable sled. Each of the sleds has an open position and a closed position. In the closed position, a composite material is moved from a starting position to an ending position that is equal to a fixed stroke of each respective sled. The stroke of each respective sled is a prescribed length of travel. Each sled is movable to the starting position when opened and movable to an ending position when closed. The process also includes a heated die positioned at the first end of the system through which the composite material is pulled. The process includes, as material exits the heated die, two of the three sleds contact the composite material and apply clamping force to the composite material at any given time to move the composite material toward the second end of the system. Two sleds move in concert with one another to move the composite material from the respective starting position for each sled to the respective ending position for each sled. While the two of the three sleds contact the composite material and move the composite material, the other of the three sleds is open and is in a non-clamping position. The other of the three sleds moves to its respective starting position and is ready to close. After one of the three sleds completes its stroke, that sled opens and the sled that is positioned at its respective starting position closes upon the composite material, applying a force thereto. The sled that has completed its stroke then returns to its starting position, with two of the three sleds that are in contact with the composite material moving the composite material toward the ending position for the respective sleds. Movement of the composite material is substantially constant from the first end to the second end and two of the three sleds are always in contact with the composite material.

A prior art level of clamping for is associated with a pultrusion system that utilizes two sleds. The level of clamping force applied by the sleds to the composite material of the three-sled process hereof is about half of the prior art level of force associated with a two-sled system.

The first sled is positioned adjacent the die and the first end. The third sled is positioned adjacent the cutting mechanism and the second end. The second sled is positioned between the first sled and the third sled. Each of the sleds is spaced from one another at all times. The process also includes a means for opening and closing the sleds and for moving the sleds throughout the process.

The process also includes utilizing a cutting mechanism to cut the composite material to a desired length, with the cutting mechanism being positioned at the second end. The composite material may cure at least partially during the process. The process may utilize software, computer hardware, and a controller for controlling the movement of the composite material.

### BRIEF DESCRIPTION OF THE DRAWINGS

FIG. 1 depicts the prior art pultrusion process that is standard in the pultrusion industry and that utilizes two sleds for pulling material;

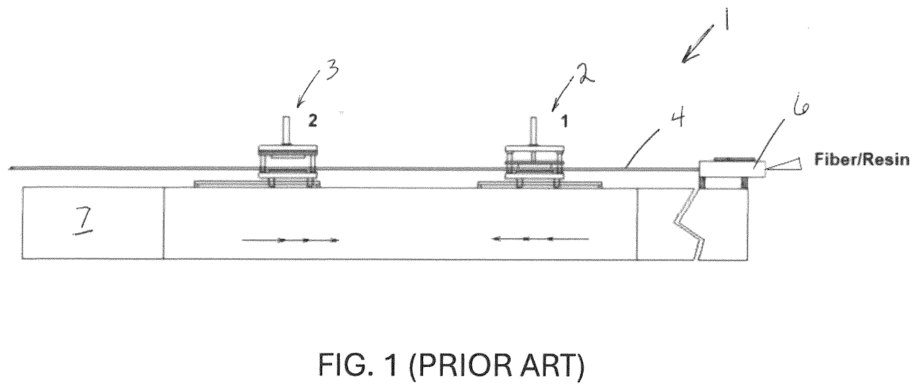

FIG. 2 depicts an end view of a sled in two separate operating positions of the inventive pultrusion process;

FIG. 3 depicts a starting, first operating position for the sleds in the pultrusion process according to the present invention;

FIG. 4 depicts a second operating position for the sleds in the pultrusion process according to the invention;

FIG. 5 depicts a third operating position for the sleds in the pultrusion process according to the invention;

FIG. 6 depicts a fourth operating position for the sleds in the pultrusion process according to the invention.

### DETAILED DESCRIPTION

The present invention concerns a new pultrusion process for forming pultruded composite materials that addresses the deficiencies known in the art. In particular, the present invention provides for more consistent movement of composite material in the pultrusion process, thereby improving overall quality of the material produced. An example of a pultrusion system is known from applicant's U.S. patent application Ser. No. 17/835,904, filed on Jun. 8, 2022, the disclosure of which is incorporated herein by reference in its entirety (“the '904 patent application”). The '904 patent application describes a pultrusion process that utilizes two pull sleds. Pull sleds have a clamping force associated with the pads of the sled clamping down on the part/composite material to pull the material through the system.

The inventive pultrusion system described herein utilizes three pulling sleds instead of the two sleds of the prior art system. By using three sleds instead of two, the system can operate continuously, which avoids the potential marking of products caused by the slight pause that was present in the prior art system. The use of three sleds allows two sleds to be in contact with the part/composite material at any given time. This helps to spread out the clamping force area and reduces the down force needed to move the composite material through the system. In one embodiment, the clamping force is reduced by approximately one-half. In another embodiment, the clamping force is reduced by less than one half but is reduced relative to the force applied in a two-sled system. As a result, the presently described system makes it less likely to damage or mark the composite material/part.

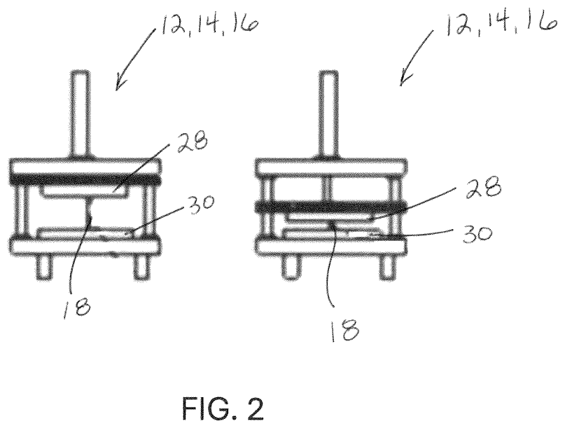

According to the invention, a tripul pultrusion process and system 10 is utilized. A tripul pultrusion process and system 10 uses three pull sleds 12, 14, 16 instead of two pull sleds 2, 3. FIG. 2 depicts schematics of sleds used in the pultrusion process. As shown, the sleds have two primary positions. A first position is an open position and a second position is a closed position. The first, open position is shown on the left side of the schematic of FIG. 2 while the second, closed position is shown on the right side of the schematic of FIG. 2. In the open position, the sled damp is open and free to move to a ready position. In the closed position, the sled damp is closed or clamped on a composite material 18 in the system and is in a ready position to pull the composite material 18.

Each pull sled 12, 14, 16 has a fixed length of travel or stroke and a time period of movement that includes a starting position, an ending position, and a length of travel. Each pull sled 12, 14, 16 can only travel from its starting position to its ending position and back to its starting position (also referred to as the ready position). When the sled 12, 14, 16 travels from the starting position to the ending position, it is closed. When the sled 12, 14, 16 travels from the ending position back to the starting position, it is open. When the sled 12, 14, 16 is in its open position, it does not control the movement of the composite material 18 through the system 10. When the sled 12, 14, 16 is in its closed position, it controls the movement of the composite material 18 through the system 10 because it is clamped down on the composite material/part 18 so that as the sled 12, 14, 16 moves, the composite material/part 18 also moves.

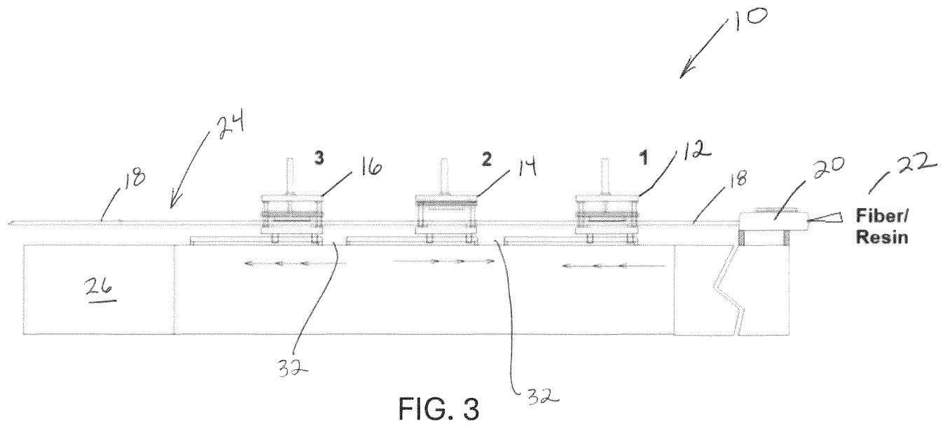

FIGS. 3-6 depict the various positions of the sleds 12, 14, 16 that result in movement of the composite material 18 through the system 10. The first pull sled 12 is referred to herein as sled 1 12. The second pull sled 14, which is positioned directly downstream from the first pull sled 12, is referred to herein as sled 2 14. The third pull sled 16 is positioned directly downstream from the second pull sled 14 and is referred to herein as sled 3 16. Sled 1 12 is positioned closest to a heated die 20. Fibers and resin 22 are combined and enter the heated die 20 to form the composite material 18. Other types of materials may also be utilized to form the composite material. Sled 3 16 is positioned closest to the end 24 of the pulling system, where a cutting mechanism 26 or saw is typically located to cut the composite material 18 off.

FIG. 3 depicts the beginning of the pulling process. In FIG. 3, sled 1 12 and sled 3 16 close and start the pulling process of the composite material 18 while sled 2 14 is in a ready position. Sleds 1 and 3 12, 16 are closed such that two pulling sleds 12, 16 are in contact with the composite material 18 as the composite material 18 moves through the system 10, shown as right to left in the schematic of FIG. 3. Sleds 1 and 3 12, 16 hold the composite material 18 between the upper plate 28 and the lower plate 30 of the sled 12, 16 to move the material 18 through the system 10. When the sleds 12, 14, 16 are in a closed position, the composite material 18 is trapped in the sled 12, 14, 16 so that the composite material 18 moves from its starting position to its ending position.

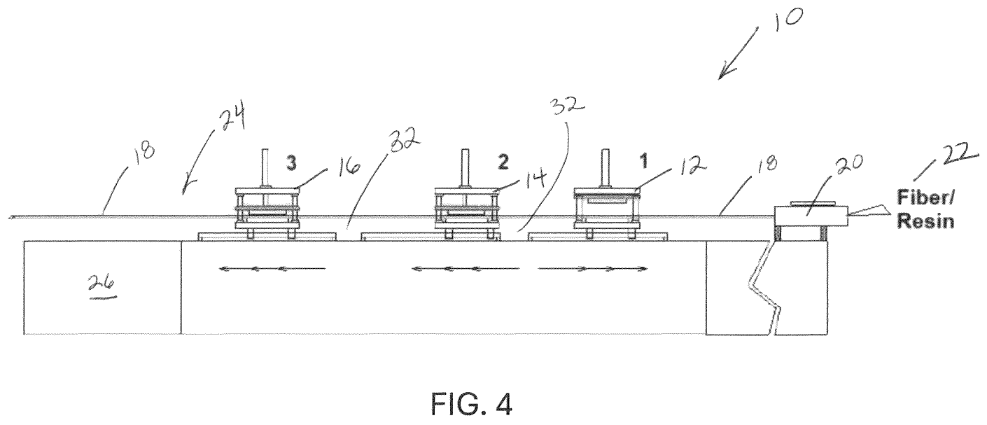

In FIG. 4, after half the distance is reached of the stroke/length of travel, sled 2 14 closes and starts pulling the composite material 18 while sled 1 12 opens, releasing the composite material 18, and returns home to its ready position. Sled 2 14 and sled 3 16 are then both in contact with the composite material 18 and continue to pull the composite material 18 toward the ending position 24.

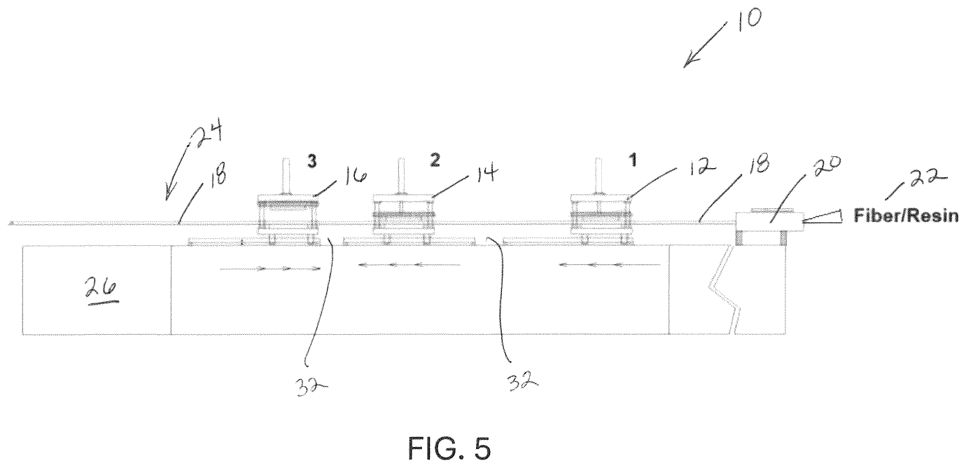

In FIG. 5, sled 1 12 closes and sled 3 16 opens while sled 2 14 remains closed on the composite material 18 and moves towards the ending position 24. When sled 3 16 opens, it returns to its ready position. Sled 1 12 and sled 2 14 are now both closed on the composite material 18 and they pull the composite material 18 toward the ending position 24.

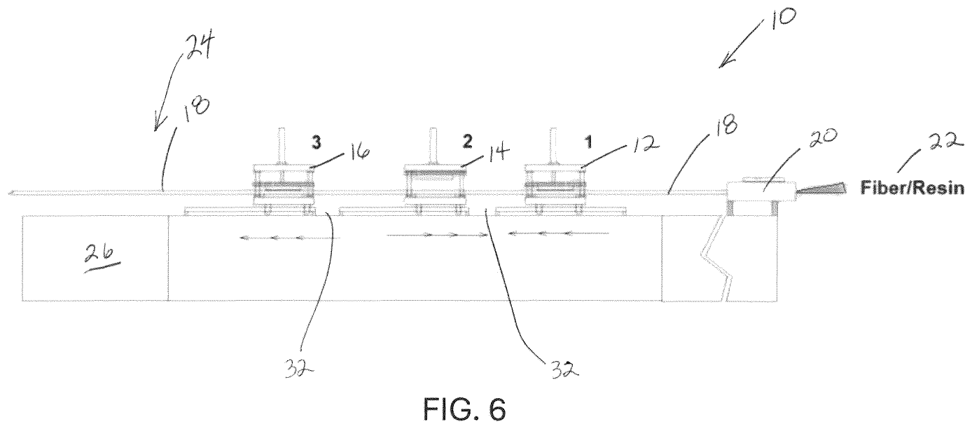

In FIG. 6, sled 3 16 closes on the composite material 18 while sled 1 12 remains in contact with the composite material 18 and sled 2 14 opens and returns to its ready position. Sled 1 12 and sled 3 16 are now in contact with the composite material 18 and pull the composite material 18 towards the ending position 24.

As is evident, two of the three sleds are always in contact with and pulling the composite material 18 while the third sled is open and returning to its ready/starting position. The composite material 18 is held by the respective sleds during the entire stroke of the respective sled. Alternatively, the composite material 18 could be released prior to the entire stroke of the sled. Each sled has the same stroke as the other sleds.

The three sleds 12, 14, 16 work in concert with one another to move the composite material 18 through the system 10. As the composite material 18 is released by one of the sleds, the free sled clamps down on the composite material 18 so that two of the three sleds are always in contact with the composite material 18.

Each sled has pads or plates 28, 30 that are configured to effectively pull the composite material 18 through the system 10. The pads 28, 30 may be made of metal or rubber/silicone so as to not distort or damage the shape of the composite material 18 during the pultrusion process. The composite material 18 is formed by the die 20 before entering sled 1 12 and the sleds are used to move the composite material 18 through the heated die 20 and system 10 until the material is cut. The sleds 12, 14, 16 may include or work in concert with a forming tool (not shown), if desired. Or a forming tool may be positioned between the sleds 12, 14, 16. Because the pulling process takes some time, the composite material 18 may cure during the pulling process. The material may reach a full cure, e.g., about 95 to about 98 percent cure, or may reach a partial cure during the stroke.

The two sleds that are in contact with the composite material 18 at any one time move simultaneously and in unison to repeat the process. The cycle of movement of the sleds 12, 14, 16 is sequentially timed and repetitive for the duration of the manufacturing process. The movement of the sleds 12, 14, 16 does not overlap, which is why there will always be an intermediate section 32 of composite material 18 between each of the sleds 12, 14, 16. This is also why the stages must be timed together in unison. In typical pultrusion or extrusion, which is only two dimensional, it is important to have the first and second stage timed together fairly closely. However, in the present process, the sleds are timed to operate in unison. Otherwise, if they are not operating in unison, a sled 12, 14, 16 could clamp down inappropriately and distort or damage the composite material 18.

Software, computer hardware, and a controller, among other computer-based products (not shown), can be used to control the motion of the sleds 12, 14, 16, as known by those of skill in the art. Curing time within the system 10 is a function of the thickness of the composite material or part 18 and thicker parts would normally take longer to cure. In addition, the fiber/resin system and catalyst utilized also have an impact on total cure time. Depending on the thickness of the composite material 18, this can take anywhere from approximately 1 minute to 10-12 minutes per cycle.

The sleds 12, 14, 16 may use servo motors to control the movement of the sleds 12, 14, 16. Alternatively, hydraulics could be used. The servo motors and/or hydraulics could be controlled by a computer, software, and a controller.

The fibers may be made of any number of different materials. Possible materials include glass or fabrics. Resin types may include polyester, polyurethane, vinyl ester, epoxy, phenolic, thermoplastics (e.g., polybutylene terephthalate (PBT), polyethylene terephthalate (PET), and other materials.

The clamping plates or pads 28, 30 of the sleds 12, 14, 16 may be shaped. The pads 28, 30 may be cast urethane pads.

A resin injecting system is utilized with the pulforming process and may include inserting a plurality of fibers into a resin injection system, injecting resin into the plurality of fibers to impregnate the resin into the plurality of fibers and pulling the impregnated fibers through a preform die to form the impregnated fibers into an initial shaped material, which may be later formed, if desired and as known in the art.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially,” if used herein, means the specified materials or steps and those that do not materially affect the basic and novel characteristics of the material or method. All percentages and averages are by weight unless the context indicates otherwise. If not specified above, the properties mentioned herein may be determined by applicable ASTM standards, or if an ASTM standard does not exist for the property, the most commonly used standard known by those of skill in the art may be used. The articles “a,” “an,” and “the,” should be interpreted to mean “one or more” unless the context indicates the contrary.

What is claimed is:

1. A pultrusion system for preparing a fiber reinforced polymer composite comprising:
a movable first sled, a movable second sled, and a movable third sled, each of said sleds having an open position and a closed position, with the closed position being utilized to clamp down upon and pull a composite material through the pultrusion system, with each of said first, second, and third sleds being movable from a starting position to an ending position and being returnable to a starting position;
a first end of the system for receiving a composite material to be pulled;
a second end that is opposite the first end of the system;
programming and a controller to permit the first, second and third sleds to pull the composite material through the pultrusion system in a substantially continuous manner from the first end to the second end,
wherein two of the first, second, and third sleds are in contact with the composite material and pulling the composite material at any one time.

2. The system of claim 1, wherein the pulling of the composite material through the system is continuous.

3. The system of claim 1, wherein the pulling of the composite material through the system is substantially continuous, without any discernable pauses.

4. The system of claim 1, further comprising a heated die positioned at a first end of the system through which the composite material is pulled.

5. The system of claim 4, further comprising a cutting mechanism for cutting the composite material at the second end.

6. The pultrusion system of claim 5, wherein the cutting mechanism is a saw.

7. The system of claim 1, wherein the sleds are aligned longitudinally with one another along a production line and are spaced from one another by an intermediate spacing.

8. The system of claim 1, wherein the intermediate spacing between the sleds is equal for each sled.

9. The system of claim 1, further comprising a means for moving and opening and closing the sleds.

10. The system of claim 1, wherein each sled hereof applies a clamping force to the composite material when the sled closes on the composite material, wherein a level of clamping force is associated with a two sled protrusion system, and the level of clamping force applied by the sleds hereof is about half of the clamping force associated with a two sled protrusion system.

11. A pultrusion process for preparing a fiber reinforced polymer composite and for moving the composite from a first end of a system to a second end of the system comprising:
a first movable sled, a second movable sled, and a third movable sled, each of said sleds having an open position and a closed position, with the closed position for moving a composite material from a starting position to an ending position that is equal to a fixed stroke of each respective sled, with the stroke being a prescribed length of travel, and with each sled being movable to the starting position when opened and movable to an ending position when closed; and
a heated die positioned at the first end of the system through which the composite material is pulled,
the process comprising:
as material exits the heated die, two of the three sleds contact the composite material and apply clamping force to the composite material at any given time to move the composite material toward the second end of the system, with the two sleds moving in concert with one another to move the composite material from the respective starting position for each sled to the respective ending position for each sled;
while the two of the three sleds contact the composite material and move the composite material, the other of the three sleds is open and in a non-clamping position and moves to its respective starting position and is ready to close,
after one of the three sleds completes its stroke, that sled opens and the sled that is positioned at its respective starting position closes upon the composite material, applying a force thereto, while the sled that has completed its stroke then returns to its starting position, with two of the three sleds that are in contact with the composite material moving the composite material toward the ending position for the respective sleds,
wherein movement of the composite material is substantially constant from the first end to the second end and two of the three sleds are always in contact with the composite material.

12. The process of claim 11, wherein a prior art level of clamping force is associated with a pultrusion system that utilizes two sleds and the level of clamping force applied by the sleds to the composite material of the three sled process hereof is about half of the prior art level of force associated with a two sled system.

13. The process of claim 11, wherein the first sled is positioned adjacent the die and the first end, the third sled is positioned adjacent the cutting mechanism and the second end, and the second sled is positioned between the first sled and the third sled.

14. The process of claim 11, wherein each of the sleds is spaced from one another at all times.

15. The process of claim 11, further comprising a means for opening and closing the sleds and for moving the sleds throughout the process.

16. The process of claim 11, further comprising a cutting mechanism for cutting the composite material to a desired length, with the cutting mechanism being positioned at the second end.

17. The process of claim 11, wherein the composite material cures at least partially during the process.

18. The process of claim 11, further comprising software, computer hardware, and a controller for controlling the movement of the composite material.
